(19) United States
(12) Patent Application Publication
(10) Pub. No.: US 2005/0079818 A1
(43) Pub. Date: Apr. 14, 2005

(54) Wireless communications system

(76) Inventors: Philip L. Atwater, Golden, CO (US); James M. DeHaan, Denver, CO (US); Malin Lester Jacobs, Centennial, CO (US)

Correspondence Address: LATHROP & GAGE LC, 4845 PEARL EAST CIRCLE, SUITE 300, BOULDER, CO, 80301, US

(21) Appl. No.: 10/625,714

(22) Filed: Jul. 23, 2003

Related U.S. Application Data
(63) Continuation of application No. 10/285,916, filed on Nov. 1, 2002.

(51) Int. Cl. H04B 7/00

(52) U.S. Cl. 455/41.2

(57) ABSTRACT

A microwave communications system enhances microwave wave propagation in tunnels, mines and the like by transmitting and receiving communications signals at frequencies ranging from 5 GHz to 15 GHz. Duplex transmissions and call signal alarm functionality provide enhanced safety features for workers.

### GOVERNMENT INTEREST

This invention was produced by employees of the United States Department of the Interior, Bureau of Reclamation using government funds. The United States Government has certain rights in the invention.

### BACKGROUND OF THE INVENTION

1. Field of the Invention

The invention pertains to the field of wireless communications and, particularly, radio or microwave transmission systems having utility in confined spaces, such as tunnels, buildings and industrial facilities.

2. Discussion of the Related Art

The United States Department of the Interior, Bureau of Reclamation, operates approximately 300 miles of water conveyance tunnels. Some of these tunnels exceed 10 miles in length. Periodically, the tunnels must be drained to provide access for maintenance operations. It is a continuing problem to provide stable communications for workers in these tunnels which, in turn, raises safety and work-efficiency issues.

Wireless signal propagation is rapidly attenuated in close environments of use, such as tunnels, mines, and the like, because surrounding rock or concrete absorbs the transmissions. Accordingly, the distances over which such transmissions may occur are very limited. Commercially available systems in use for these purposes require excessive times for set-up and are unreliable over the long term because the signal attenuation problem has not been overcome.

U.S. Pat. No. 4,866,732 to Carey et al. describes a wireless telecommunications system for use in mines. The '732 system uses a leaky transmission cable to facilitate communications, e.g., through use of such as a slit coaxial cable. It is difficult to string such cables, and once in place the cables are subject to breakage or deterioration. For example, in a tunnel that is used to transport water, the cable must be redeployed for each use because the effects of water exposure would significantly degrade or dislodge the cable if it were left in place between uses. Furthermore, the cables tend to break or cause other problems. The passage of heavy equipment, blasting operations, and falling rock create conditions that are not amenable to long-term stability of such systems.

Wireless systems may overcome the disadvantages of having to string leaky cables through enclosures, but wireless systems are burdened by signal attenuation problems. By way of example, U.S. Pat. No. 6,359,871 to Chung et al. describes the present state of the art where a need for wireless mine communication systems has been felt since the 1920's. None of the wireless systems that have been commercially implemented are adequate to the task because the signal attenuation problems have not been overcome. The '871 patent indicates that leaky coaxial transmission systems are problematic because significant signal attenuation occurs even in the coaxial cable. Thus, a variety of slave-repeater stations must be installed in such systems. The '871 patent proposes to resolve the problems of leaky coaxial cable systems by installing a wireless cellular repeater system. The '871 patent reports selecting the ISMA band from 902 to 928 MHz for cellular transmissions because the signals are completely retained underground and because higher frequencies for example, of 1000 MHz have excessive signal loss around corners. In this band, wireless slave-repeater stations must be set-up no more than 200 meters to 500 meters apart due to the signal attenuation problem. Each repeater is a potential point of failure.

Radio transmission systems are available for transmitting in the high UHF band, but these systems are not generally viewed as being useful in mines or tunnels. For example, U.S. Pat. No. 6,072,991, describes a terrestrial line-of-sight communication system that transceives in a frequency range of 2 GHz to 94 GHz. The '991 system is not specifically used in tunnels or mines, and transmissions at these higher frequencies are generally not understood to be useful in tunnels or mines.

There remains a need to provide an underground wireless communications system having less signal attenuation, such that repeaters may be spaced farther apart and/or eliminated.

### SUMMARY

The wireless communications system shown and described herein overcomes the signal attenuation problems outlined above by transmitting at a higher frequency than is reported in the art. The system also has a variety of features that adapt the system for the intended environment of use.

The wireless communications system is used to communicate in confined spaces or enclosures, such as mines, tunnels, industrial enclosures, buildings and the like. A pair of transceivers are configured to transmit and receive signals through the enclosure at frequencies ranging from 5 GHz to 15 GHz, more preferably from 8 GHz to 12 GHz, and most preferably at 10 GHz plus or minus three percent. It has been discovered, for example, that transmission at these frequencies permit transmission at distances in excess of thirteen miles through concrete lined water conveyance tunnels and that such tunnels have a limited channeling effect at these frequencies. This level of performance may be obtained in systems that transmit at a power output of 100 miliwatts, 35 miliwatts, or less, which is generally regarded as a safe level of RF exposure for workers. This level of power consumption means that each transceiver may operate for an extended period of time while being supplied by a 12 volt automotive-type battery.

In some embodiments, the transceivers are configured for duplex transmission of communications signals with built-in signal lock controls. One transceiver may transmit a call signal to the other, which detects the signal and responds with a confirmation signal indicating that the call signal was received. Receipt of the confirmation signal indicates that the recipient of the call signal was notified that the call signal arrived. Call signal detection constitutes an advantageous safety feature that is enhanced by full duplex transmission.

Circuitry may be provided detecting loss of signal lock. This detection may be accomplished on the basis of signal strength and/or loss of center tune frequency.

In other aspects, the wireless communications system is used in a method of wireless communication through confined spaces, such as mines, tunnels, industrial enclosures, buildings and the like. A first transceiver is positioned within an enclosure of the type described above. A second transceiver is placed in a position where the second transceiver is capable of establishing wireless communications with the first transceiver. The first and second transceivers then transmit and receive microwave signals through the enclosure at frequencies in a range from 5 GHz to 15 GHz. The transmitted signal may be a full duplex signal that can contain an embedded call signal and/or conformation signal. A step of detecting loss of frequency lock in the full duplex transmission may be performed on the basis of signal strength and/or loss of center tune frequency.

### DESCRIPTION OF THE DRAWINGS

FIG. 1. depicts a wireless communications system that includes a pair of transceivers configured for communicating through a tunnel;

FIG. 2 shows experimental data that confirms superior performance of microwave propagation in Azotea tunnel;

FIG. 3 depicts Azotea tunnel signal propagation at 2.0 GHz in comparison to a free space propagation curve;

FIG. 4 depicts Azotea tunnel signal propagation at 6.0 GHz in comparison to a free space propagation curve;

FIG. 5 depicts Azotea tunnel signal propagation at 11.0 GHz in comparison to a free space propagation curve;

FIG. 6 depicts Azotea tunnel signal propagation at 16.0 GHz in comparison to a free space propagation curve;

FIG. 7 is a plan view of a schematic showing Soap Lake Siphon located near Ephrata, Wash.;

FIG. 8 is a vertical section view of a schematic showing the Soap Lake Siphon;

FIG. 9 shows experimental data that confirms superior performance of microwave propagation in Soap Lake Siphon; and

FIG. 10 is a schematic block diagram showing a transceiver.

### DETAILED DESCRIPTION

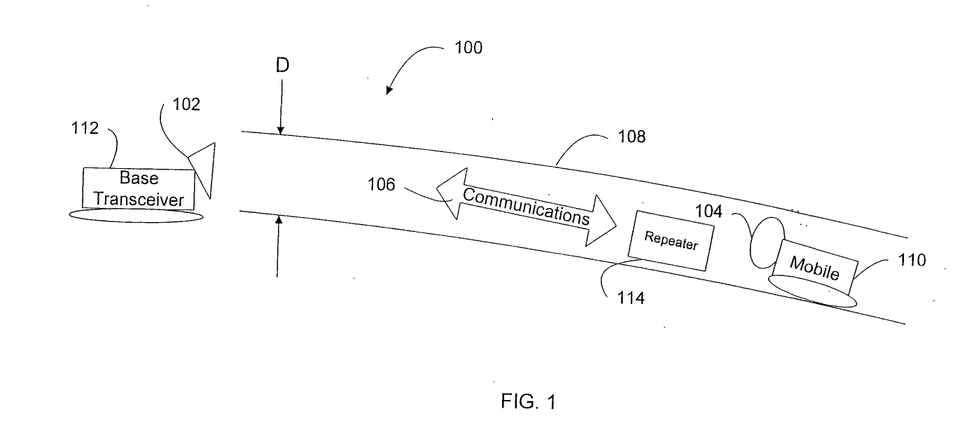

FIG. 1 depicts a microwave communications system 100 including a base transceiver 102 and a mobile interior transceiver 104. The base transceiver 102 and the mobile interior transceiver 104 transmit, for example, full duplex microwave communications signals 106 to one another that facilitate maintenance operations within a water conveyance tunnel 108. The mobile interior transceiver 104 may be hand-carried or mounted on a conveyance 110, such as a wheeled vehicle or a tracked vehicle. The base transceiver 102 may be mounted on a base station 112, such as a fixed positional mount, a tripod mounting device or any type of vehicle.

Duplex communication functionality in microwave communications system 100 permits users at either or both transceivers 102, 104, to talk and listen at the same time. Communications signals 106 preferably occur at frequencies ranging from 5 GHz to 15 GHz. At frequencies lower than about 5 GHz, signal attenuation rises due to tunnel adsorption of signal power. At frequencies greater than about 15 GHz, attenuation rises due to signal adsorption into moisture in the air.

It has been discovered that within the range of 5 GHz to 15 GHz signal reflection and/or ducting of communications signal 106 occurs, such that tunnel 108 functions as a channel. This channeling effect permits signal transmission around shallow bends or corners having up to a 10°, 30°, or even a 45° deviation from a straight line. For duplex communications, it is preferred that the transceivers 102, 104 transmit on slightly different frequencies, for example, frequencies that are separated by about one to three one-thousandths of the total transmission frequency. In one example where the transceivers 102, 104 operate generally at 10.00 GHz, transceiver 102 may transmit at 10 GHz and transceiver 104 may transmit at 10.03 GHz. In turn, transceiver 102 receives at 10.03 GHz (i.e., for the transmission from transceiver 104) or at least over a band encompassing this frequency, and transceiver 104 similarly receives at 10.00 GHz.

The effective propagation distance of communications signals 106 within tunnel 108 may vary as a function of a nominal tunnel diameter D, tunnel geometry, tunnel construction material, and the power that is applied to the transmission. For safety reasons and health concerns, it is desirable to utilize low power transmissions. By way of example, such transmissions may have a total power output of less than 100 miliwatts on a four inch horn antenna and still transmit with an acceptable safe power density of 25 miliwatts per square inch at 10 GHz. As will be shown in the following examples, it has been discovered that utilizing transmission frequency in the microwave range is the best way to enhance signal penetration into a mine or tunnel, even when the mine or tunnel has a convoluted geometry. These transmissions may occur over distances of several miles without necessarily having to resort to use of repeater stations 114.

### EXAMPLE 1

### Signal Propagation in Azotea Tunnel

The Bureau of Reclamation operates Azotea tunnel, which is a water conveyance tunnel located near Chama, N. Mex. The tunnel is eleven feet in diameter, thirteen miles long, has a straight and uniform geometry, and is concrete lined. The water level in the tunnel was sufficiently lowered to permit access by Bureau personnel. A comparative study of signal propagation distance was performed in this tunnel. The comparative study involved: commercially available radios transmitting at 160 MHz, 400 MHz, and 900 MHz; a lossy feeder system; and a super high frequency transmitter.

Hand-held radios normally used by Bureau personnel transmitting at 160 MHz and five watts of power were found to be useless when separated by about 0.2 miles or roughly 1000 feet in Aztoea tunnel. Commercially available radios transmitting at 400 MHz and two watts of power were obtained from Safe Environment Engineering. The 400 MHz radios were effective over no more than about 0.4 miles. Other commercially available radios transmitting at 936.6 MHz and using three watts of transmission power were obtained from Motorola. These 900 MHz radios were effective over no more than about 0.8 miles when one radio was located just outside the tunnel mouth and 1.5 miles when both radios were located inside the tunnel. A lossy feeder system operating at 280 to 520 kHz was obtained from RIMtech and connected to a cable that was unrolled into the tunnel, but the system quit working when the cable was accidentally tugged and a repeater fell into water that continued to flow along the bottom of the tunnel. The lossy feeder system requires repeaters every 0.4 miles. These measurements show a maximum signal penetration distance of less than one mile without repeaters. Accidental disruption of the lossy feeder system confirmed the difficulty of using cable systems.

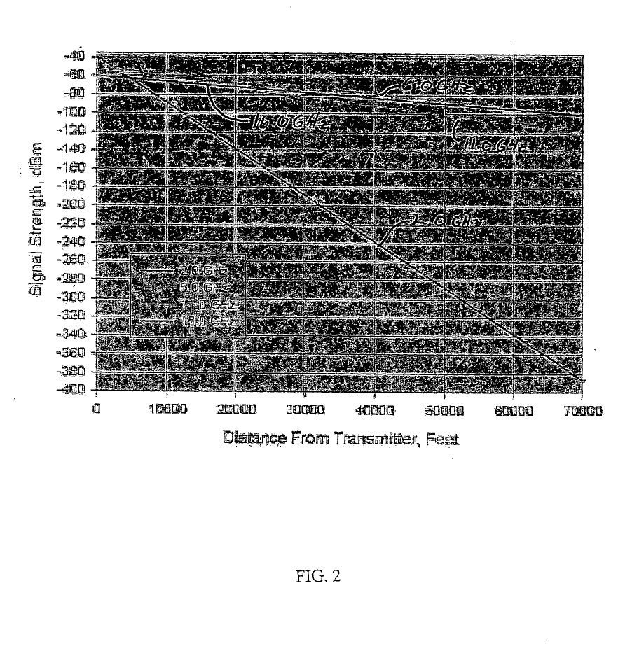

The super high frequency transmitter was tuned to a range of transmission frequencies including 2.0 GHz, 6.0 GHz, 11.0 GHz, and 16.0 GHz. Transmitter source transmission occurred at +10 Dbm. A compatible receiver was positioned at successive distances into the tunnel including distances of 150 feet; 1,150 feet; 2,150 feet; 3,150 feet; 4,150 feet; 5,150 feet; 6,150 feet; 8,150 feet; 10,150 feet; 15,150 feet; 16,150 feet; and 17,150 feet into the tunnel. FIG. 2 shows the received signal strengths as a function of distance where the signal strengths are extrapolated out to 70,000 feet. The 2 GHz signal demonstrated relatively rapid attenuation when compared to the 6, 11 and 16 GHz transmissions.

A mathematical model was used to predict the signal propagation strength in free space for each of the 2 GHz, 6.0 GHz, 11.0 GHz, and 16.0 GHz transmissions, according to an equation for free space attenuation provided in Reference Data for Radio Engineers, Howard Sams & Co., Inc, 1975, pp. 18-29:
α=20 log f+20 log d−37.9, (1)
where α is free space attenuation in dB, f is frequency in MHz, and d is distance in feet.

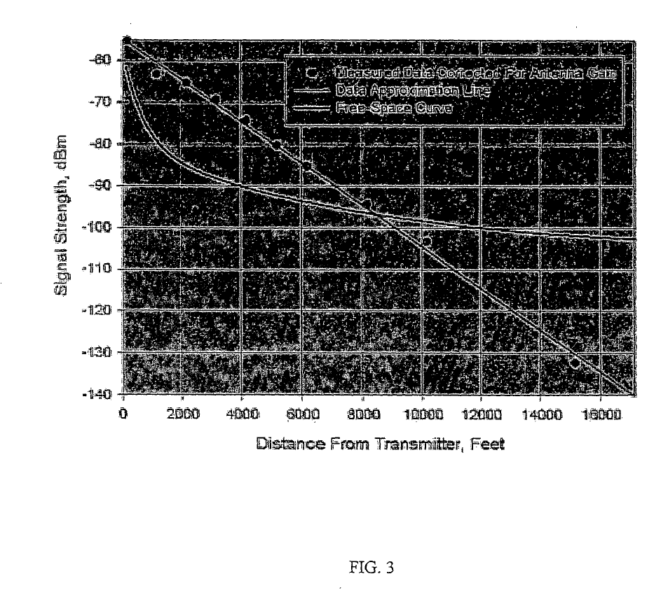

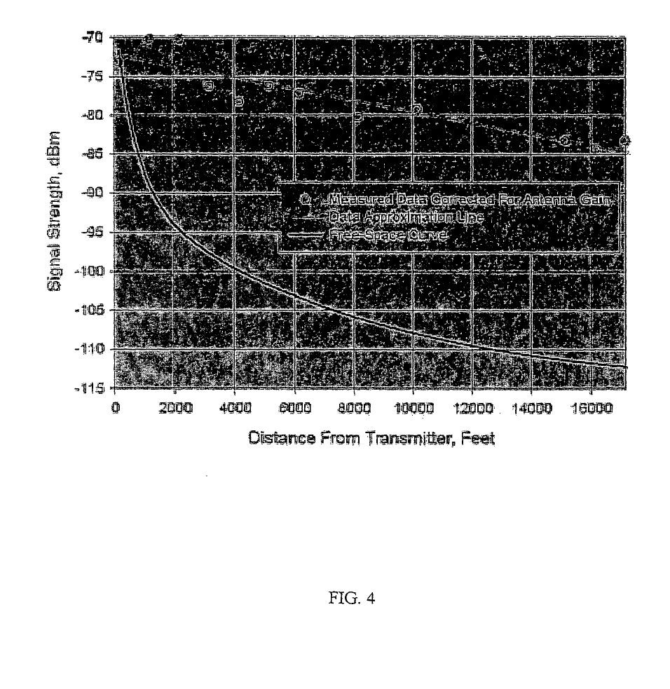

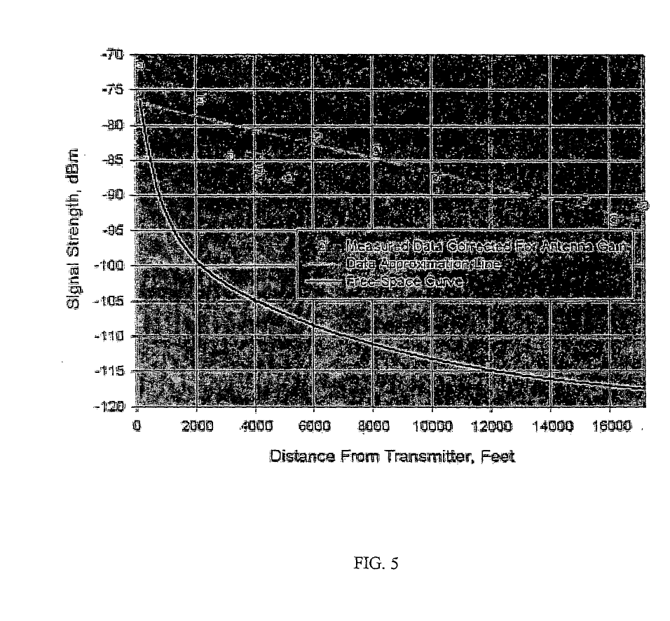

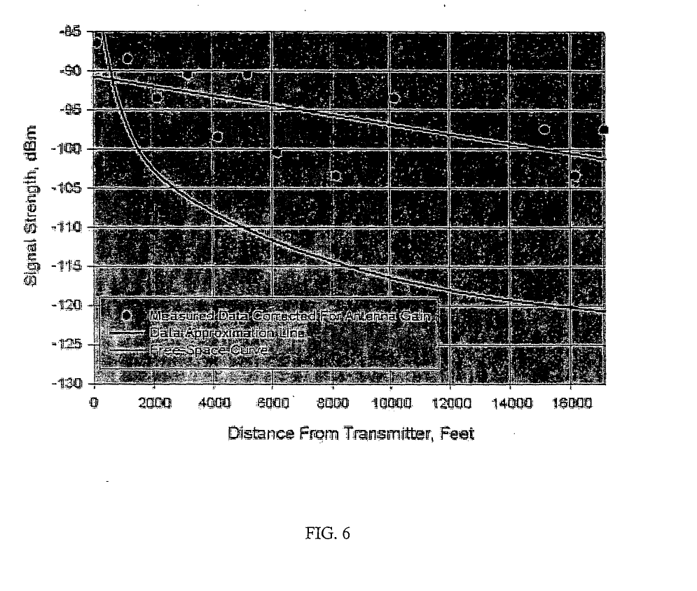

The model was corrected for gains in the transmitting and receiving antennae, and the calculation results were used to establish a baseline signal strength. FIG. 3 (2.0 GHz), FIG. 4 (6.0 GHz), FIG. 5 (11.0 GHz), and FIG. 6 (16.0 GHz), provide a comparison between the observed and calculated free space signal strengths at distances out to 17,150 feet. The fact that the observed signal strengths exceed the free space signal strengths indicate that the tunnel was acting beneficially as a channel; however, the net channeling effect was only extant out to 8000 feet in the case of the 2.0 GHz transmission shown in FIG. 3.

### EXAMPLE 2

### Signal Propagation in Soap Lake Siphon

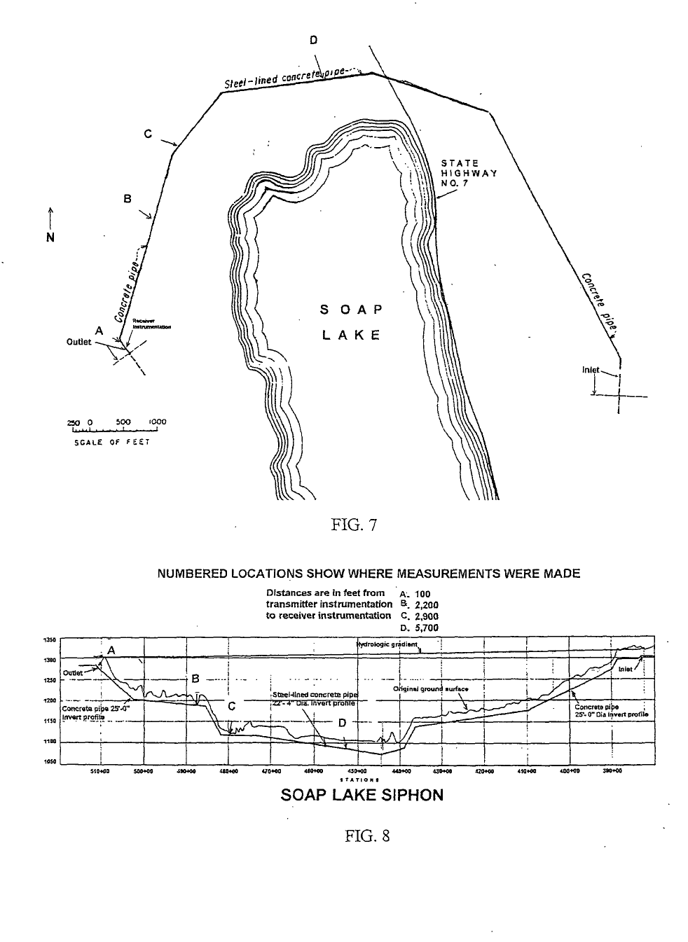

The Bureau of Reclamation operates Soap Lake Siphon, which is a water conveyance tunnel located near Ephrata, Wash. The tunnel is twenty-five feet in diameter, and two and one-half miles long. The Soap Lake Siphon was selected because it has a complex geometry presenting significant changes in direction in both the vertical and horizontal planes. The Soap Lake Siphon has two different types of linings that include concrete and steel-lined concrete. FIG. 7 is a plan view of the tunnel schematic showing horizontal changes in direction. FIG. 8 is a sectional tunnel schematic showing changes in elevation in respect to a hydrologic gradient. The water level was sufficiently lowered to permit access by Bureau personnel. Soap Lake Siphon was selected for its geometry, which differs from the straight-bore Azotea Tunnel. Geometric features include:
a 45° elbow 800 (FIG. 8) between points A and B;
a 25° corner 700 (FIG. 7) and a 60° drop 802 (FIG. 8) between points B and C; and
a 45° corner 702 between points C and D.

The tests that were performed in Example 1 were replicated in the Soap Lake Siphon, except fewer radio types were used, test distances were shorter, and SHF transmission occurred at 10 miliwatts. The comparative study involved commercially available radios transmitting at 600 MHz, 900 MHz. The super high frequency transmitter was evaluated at 2.0 GHz, 6.0 GHz, 11.0 GHz, and 16.0 GHz. Compatible receivers were positioned at successive distances into the tunnel including distances of 100 feet (A); 2,200 feet (B); 2,900 feet (C), and 5,700 feet (D) feet into the tunnel.

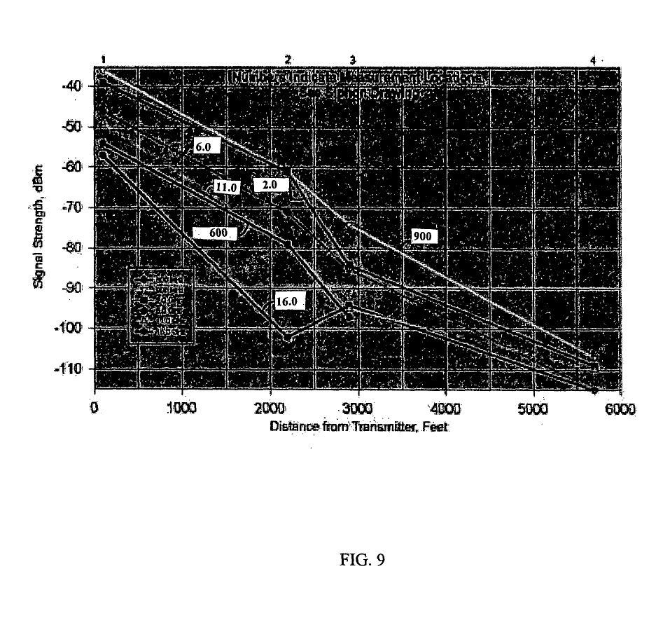

FIG. 9 shows the received signal strengths as a function of distance The results shown in FIG. 9 indicate that the larger diameter of the Soap Lake Siphon produced less signal attenuation in the lower frequencies than did Azotea tunnel on straight runs, and that the channeling effects of the tunnel permit signals to travel around geometric features of the tunnel. Extrapolation of the curves shows substantial convergence at about 6000 feet; however, the SHF frequencies were transmitted at lower power of 10 miliwatts.

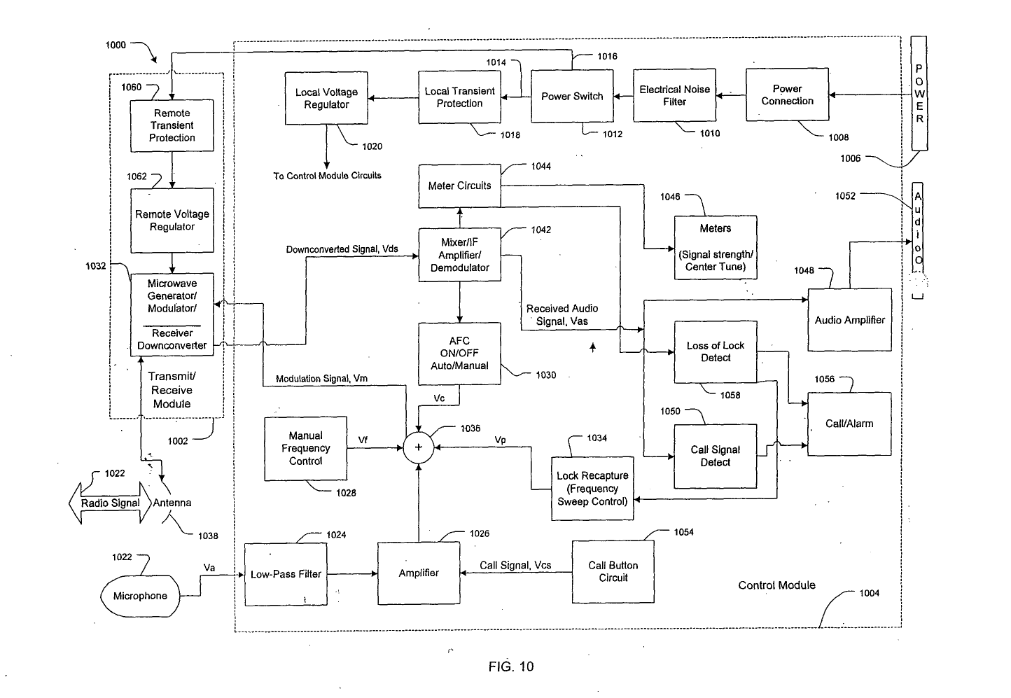

FIG. 10 is a block schematic diagram of a tunnel transceiver 1000 that may function as either transceiver 102 or 104. Transceiver 1000 contains a transmit and receive module 1002 and a control module 1004. A power supply 1006 may be any compatible source of power, such as a battery, generator, or any other external power system capable of providing required system voltages. For example, power supply 1006 may be a 12 volt automotive-type battery or another battery providing a voltage in the range of 11 to 16 volts. Power from the power supply 1006 is applied to a power connection 1008. An electrical noise filter 1010, e.g., an inductor-capacitor network, eliminates conducted electrical noise. A manually actuable power switch 1012 splits the applied power into two paths. Path 1014 provides power to the control module 1004, and path 1016 provides power to the transmit/receive module 1002. On path 1014, a local transient protection circuit 1018 provides further filtering and/or surge protection prior to delivery of power to local voltage regulator 1020 which, in turn, supplies power to control module 1004.

Users of tunnel transceiver 1000 begin the process of transmission by speaking into a microphone 1022, which provides an audio signal output, Va. By way of example, the microphone 1022 can be incorporated into a headset or may be built into a housing (not shown). The audio signal, Va, passes into a low pass filter 1024, which removes frequencies above approximately 5 kHz. This filtering is performed to prevent false activation of other circuits within tunnel transceiver 1000 that provide call detect functionality described below. An amplifier 1026 increases the voltage strength of the signal Va.

A manual frequency control 1028 is a user-actuable input device, such as a knob, that is used to set or select the base operating frequency of tunnel transceiver 1000 by establishing a DC reference voltage Vf. An automatic frequency control circuit (AFC) 1030 provides a DC correction voltage, Vc, that compensates for frequency drift, which is primarily a thermal phenomenon of a microwave generator circuit 1032. AFC 1030 is optionally provided with an auto/manual switch that selectively enables or disables automatic compensation for frequency drift.

A lock recapture circuit 1034 is activated to perform frequency sweep control if a signal lock with a remote transceiver (not shown) is lost. If activated, the lock recapture circuit 1034 transmits a ramp Vp that causes microwave generator circuit 1032 to sweep over the entire available frequency range in an attempt to recapture lock with the remote transceiver. This is possible because a pair of transceivers 1000 operate in a full duplex mode through which both transceivers continuously or periodically transmit. Signal strength and center tuning is used to determine whether frequency lock exists on the basis of received signals.

A summation device 1036 sums signals from the amplifier 1026, manual frequency control 1028, AFC 1030 and lock recapture circuit 1034. The sum of these signals is the modulation signal Vm, which is input to the microwave generator circuit 1032 located in the transmit/receive module 1002. The microwave generator circuit 1032 generates microwave energy at a frequency from 5 GHz to 15 GHz. This microwave energy is modulated by the modulation signal Vm. The resulting microwave signal is applied to antenna 1038 and output as a communications signal 106. The antenna 1038 may, for example, be a horn-type or high gain directional antenna.

Incoming communications signals 106 are received by antenna 1038 and applied to a microwave receiver downconverter circuit 1032. By way of example, the microwave generator/modulator circuit and the microwave receiver downconverter circuit 1032 may be purchased in a combined package that is commercially available as the Gunnplexer™, which is available from Microwave Associates of Burlington, Mass. The downconverted signal, Vds, is applied to a mixer/IF amplifier/demodulator circuit 1042 which, in turn, produces three different signals. One such signal is input to the AFC 1030, which outputs this signal to summation device 1036. Another signal is input to meter circuits 1044, which process the signal to provide voltage input to meters 1046 including one meter showing relative signal strength of the received communications signal 106 and another meter indicating whether the transceiver 1000 is tuned to the center frequency of the received signal or mistuned to either side of the center frequency. The third signal from mixer/IF amplifier/demodulator circuit 1042 is a received audio signal Vas, which is input to an audio amplifier 1048 and a call signal detect circuit 1050. The audio amplifier 1048 amplifies the signal Vas, which is applied to an audio output device 1052, i.e., a speaker, which by way of example may be incorporated in a set of headphones that are utilized for the hearing of voice transmissions contained in communications signals 106. Due to the nature of duplex operation, the user is also able to hear himself or herself speak through audio output device 1052.

The call signal detect circuit 1050 allows one transceiver operator to call another when the message recipient is not present at tunnel transceiver 1000 or when the message recipient is not within audible range of the audio output device 1052. A call button circuit 1054 is provided where actuation of the call button circuit 1054 creates a call signal Vcs, for example, an amplitude modulated signal with an ultrasonic carrier and a subsonic modulating frequency. By way of example, the ultrasonic carrier may be transmitted at 25 Hz using a subsonic modulating frequency of 10 Hz. The call signal Vcs is inaudible because the carrier frequency is ultrasonic. The call signal Vcs is applied to the amplifier 1026 and summed through summation device 1036 for eventual transmission through antenna 1038.

When a call signal is received in communications signals 106 by antenna 1038, control module 1004 processes the call signal as part of the received audio signal that is output from the mixer/IF amplifier/demodulator circuit 1042. The call signal detect circuit 1050 demodulates the received audio signal to recover the incoming call signal and, if the subsonic modulating signal is present for longer than a minimum threshold period of time, activates the call alarm circuit 1056. The call alarm circuit 1056 notifies the message recipient that a transmission awaits. Notification maybe accomplished, for example, by sounding a loud audible alarm and/or flashing a visible light. The amplitude modulation scheme of Vcs, in combination with the time threshold delimiter of the call signal detect circuit 1050, prevents inappropriate activation of the call signal detect circuit by spurious signals or noise.

Duplex operation facilitates implementation of an additional safety feature through which the receiving transceiver 102, 104 notifies the transmitting receiver that a call request has been received. In one example, when the call button circuit 1054 is actuated at transceiver 1000 for transmission of a call signal to a compatible transceiver, detection of the incoming signal Vcs can activates the corresponding call button circuit 1054. Alternatively, the call signal Vcs is summed in the output from mixer 1042 and input to the summation device 1036 for rebroadcast back to the sending transceiver. Thus, an outgoing call signal Vcs from the compatible receiver functions as a confirmation signal back to the initial transceiver 1000. Accordingly, if the called transceiver's call signal detect circuit 1050 does not operate correctly or if the initial call signal Vcs is not transmitted and received, the calling transceiver's call alarm circuit 1056 will not activate. This notifies the sender of the first call signal Vcs that the call signal was not received by the intended recipient.

A loss of lock detect circuit 1058 monitors the voltage level that is applied to the signal strength and center tune meters in meter circuit 1046. If the signal strength falls below a minimum level or if the tuning moves too far from center frequency, the loss of lock detect circuit 1058 activates the call alarm circuit 1056 on both transceivers. The visual and/or audio signal presentation that is activated by loss of lock detect circuit 1058 may be modulated differently than when the call alarm circuit 1056 is activated by call signal detect circuit 1050, in order that the user may distinguish between the different modes of activation. The lock recapture circuit 1034 may be optionally provided with an auto/manual switch that selectively enables or disables automatic scanning upon loss of lock. Thus, the user may use the manual frequency control 1028 to scan for audible signals if received communications signals 106 are too weak for detection by the loss of lock circuit 1058.

The control module 1004 and the transmit/receive module 1002 may be respectively housed in water resistant containers. The respective modules 1002, 1004 may be connected by cables that permit the respective modules 1002, 1004 to be used remotely from one another. For example, antenna 1038 and the transmit/receive module 1002 may be located just inside a tunnel while the control module 1004 is located just outside the tunnel.

It will be appreciated that power supply on path 1016 proceeds through a remote transient protection circuit 1160 and a remote voltage regulator circuit 1062 in like manner with respect to the local transient protection circuit 1018 and the local voltage regulator circuit 1020. It will be further appreciated that the system components shown in FIG. 10 may be combined into shared circuits or broken out into circuit that perform the functions described in separate locations. The functionality attributed to circuits may also be accomplished with the assistance of software and/or stored data. Furthermore, some functions may be eliminated, for example, by eliminating the manual frequency control to assure that communications are not lost as a result of operator error, and/or by fully automating AFC 1030, as well as the lock recapture circuit 1034.

The foregoing discussion is intended to illustrate the concepts of the invention by way of example with emphasis upon the preferred embodiments and instrumentalities. Accordingly, the disclosed embodiments and instrumentalities are not exhaustive of all options or mannerisms for practicing the disclosed principles of the invention. The inventors hereby state their intention to rely upon the Doctrine of Equivalents in protecting the full scope and spirit of the invention.

1. A microwave transmission system for use in communicating in confined spaces, such as mines, tunnels, industrial enclosures, buildings and the like, comprising:
an enclosure selected from the group consisting of a mine, a tunnel, an industrial enclosure, and a building; and
a pair of transceivers configured to transmit and receive signals through the enclosure at frequencies ranging from 5 GHz to 15 GHz.

2. The microwave transmission system of claim 1, wherein the frequencies range from 8 GHz to 12 GHz.

3. The microwave transmission system of claim 1, wherein the frequencies range between 10 GHz plus or minus three percent.

4. The microwave transmission system of claim 1, wherein the pair of transceivers are configured for duplex transmission of communications signals.

5. The microwave transmission system of claim 4, wherein the pair of transceivers each include circuitry for transmitting call signals and circuitry for detecting the call signals, where the call signals indicate a request for a call signal recipient to man one of the transceivers.

6. The microwave transmission system of claim 5, wherein the circuitry for detecting call signals further includes circuitry for confirming that the call signals have been detected at a power output that is generally regarded as a safe level of RF exposure to workers.

7. The microwave transmission system of claim 1, wherein each transceiver in the pair of transceivers is configured to operate at a power output of about 35 miliwatts or less.

8. The microwave system of claim 1, further comprising circuitry for detecting loss of signal lock.

9. The microwave system of claim 8, wherein the circuitry for detecting loss of signal lock comprises means for detecting loss of signal lock on the basis of signal strength.

10. The microwave system of claim 8, wherein the circuitry for detecting loss of signal lock comprises means for detecting loss of signal lock on the basis of center tuning.

11. The radio system of claim 1, wherein the pair of transceivers are configured to operate from power supplied by a 12 volt automotive battery.

12. A method of communicating by radio in confined spaces, such as mines, tunnels, industrial enclosures, buildings and the like, comprising:
positioning a first transceiver within an enclosure selected from the group consisting of a mine, a tunnel, an industrial enclosure, and a building;
placing a second transceiver in a position where the second transceiver is capable of signal communications with the first transceiver; and
transmitting and receiving microwave signals through the enclosure between the first and second transceivers where the microwave signals are transmitted at frequencies ranging from 5 GHz to 15 GHz.

13. The method of claim 12, wherein the frequencies used in the step of transmitting range from 8 GHz to 12 GHz.

14. The method of claim 12, wherein the frequencies used in the step of transmitting range between 10 GHz plus or minus three percent.

15. The method of claim 12, wherein the step of transmitting includes transmitting and receiving a duplex signal.

16. The method of claim 15, further comprising a step of sending a call signal from one of the first transceiver and the second transceiver, where the call signal indicates a request to communicate through use of the transmitting step.

17. The method of claim 16, further comprising a step of the other of the first transceiver and the second transceiver sending a confirmation signal upon receipt of the call signal, where the confirmation signal indicates that the call signal was received.

18. The method of claim 12, wherein the step of transmitting includes transmitting a power of 35 miliwatts or less.

19. The method of claim 12, further comprising a step of detecting loss of signal lock in a duplex transmission.

20. The method of claim 19, wherein the step of detecting loss of signal lock includes detecting loss of signal lock on the basis of signal strength.

21. The method of claim 19, wherein the step of detecting loss of signal lock includes detecting loss of signal lock on the basis of center tuning.

22. The method of claim 12, further comprising a step of connecting one of the first transceiver and the second transceiver to a 12 volt battery.
